(19) United States
(12) Patent Application Publication
(10) Pub. No.: US 2009/0061305 A1
(43) Pub. Date: Mar. 5, 2009

(54) BATTERY CONTAINER UNIT

(75) Inventors: Yoshikazu NISHIDA, Utsunomiya-shi (JP); Kenji Tsukamoto, Shioya-gun (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/199,399

(22) Filed: Aug. 27, 2008

(30) Foreign Application Priority Data
Aug. 29, 2007 (JP) 2007-223056
Aug. 29, 2007 (JP) 2007-223057

(51) Int. Cl. H01M 2/02

(52) U.S. Cl. 429/164

(57) ABSTRACT

A battery container unit including: an enclosure; and a plurality of battery modules of cylindrical shape, wherein each adjacent pair of the electrode terminals is serially connected by a conductive linking member, the plurality of battery modules are provided in matrix form within the enclosure by a support member, a first cooling medium flow path is provided which linearly flows a cooling medium along in parallel with the electrode terminals and the conductive linking members of the plurality of battery modules in a region within the enclosure near an end in the axial direction of the plurality of battery modules, and a second cooling medium flow path is provided in a gap along the axial direction of the battery modules, between adjacent battery modules within the enclosure, which flows the cooling medium toward the first cooling medium flow path.

### BACKGROUND OF THE INVENTION

1. Field of the Invention

This invention is related to a battery container unit.

Priority is claimed on Japanese Patent Application No. 2007-223056, filed Aug. 29, 2007, and on Japanese Patent Application No. 2007-223057, filed Aug. 29, 2007, the contents of which are incorporated herein by reference.

2. Description of Related Art

As driving electrical sources for electric cars, in addition to parallel placement of a plurality of nearly cylindrical battery modules within an enclosure, battery container units are known that serially connect, by conductive linking members, internal adjacent battery modules.

Every battery module generates heat from electrical charging and discharging for this kind of battery container unit. Because of the heat generated, it is necessary to efficiently cool the battery module in order to effectively use the capability of the battery module.

Because of this requirement, feed ports and exhaust ports are provided for cooling medium within the enclosure for a battery container unit which will deal with such cooling necessity. A cooling medium, such as air taken from the feed port, is put towards the outer peripheral surface of every battery module and all of the battery modules start to cool from the air passing to the outer peripheral surface (reference, for example, Japanese Unexamined Patent Application, First Publication No. 2006-134853).

However, conventional battery container units cool principally by a cooling medium. Within the battery modules in the enclosure, the outer peripheral surfaces are cooled by the cooling medium. Because of this limitation, one cannot say that the cooling efficiency for each battery module is sufficient. In addition, in order to sufficiently cool every battery module, a large flow of cooling medium must be guided to the outer peripheral surface of every battery module. As a cooling medium flow path of large cross-sectional area is needed, conventional battery container units are constructed so that a sufficient gap exists between adjacent battery modules within the enclosure. Accordingly, it is not possible to avoid enlargement of the unit's entire body.

Because of these deficiencies in conventional design, currently, cooling medium is actively guided to a conductive linking member linking companion electrode terminals of adjacent battery modules. Efficient cooling of each battery module by the conductive linking member and the electrode terminal has been studied. However, in this instance, within the enclosure, a plurality of battery modules are arranged in parallel, and the plurality of conductive linking members, oriented downstream from upstream along the cooling medium flow, become arranged in parallel. When the heat release region (for example, the region where the surface area is made large by bending) near the center in the longitudinal direction for every conductive linking member are arranged serially along the flow direction of the cooling medium, conductive linking members positioned on the downstream side of the cooling medium flow, are greatly affected by the heat released from the upstream conductive linking member. According to this effect, the cooling capability for each battery module becomes inconstant. It becomes difficult to utilize the capability of the entire battery container module to a maximum. In order to avoid this shortcoming, no other choice exists except to make the cross-sectional surface area of the cooling flow path large.

An object of this invention is to provide a battery container unit which can miniaturize the entire unit and enhance the cooling efficiency of the battery modules within the enclosure.

### SUMMARY OF THE INVENTION

In order to accomplish the above described object, the present invention employed the following.

(1) A battery container unit including: an enclosure; and a plurality of battery modules of cylindrical shape, arranged in parallel within the enclosure, each having an electrode terminal at an end in the axial direction, wherein each adjacent pair of the electrode terminals is serially connected by a conductive linking member, the plurality of battery modules are provided in matrix form within the enclosure by a support member, a first cooling medium flow path is provided which linearly flows a cooling medium along in parallel with the electrode terminals and the conductive linking members of the plurality of battery modules in a region within the enclosure near an end in the axial direction of the plurality of battery modules, and a second cooling medium flow path is provided in a gap along the axial direction of the battery modules, between adjacent battery modules within the enclosure, which flows the cooling medium toward the first cooling medium flow path.

Within the battery container unit, the cooling medium which is guided to the first cooling medium flow path linearly flows along and in parallel with the electrode terminal at the ends in the axial direction and with the conductive linking member of every battery module. At this time, the electrode terminals and conductive linking members of every battery module are cooled. In addition, flow of the cooling medium is induced in the second cooling medium flow path between adjacent battery modules from the flow of cooling medium within the first cooling medium flow path. The outer peripheral surface of every battery module is cooled from the flow of this induced cooling medium.

In addition, from the cooling medium of the first cooling medium flow path which flows linearly in parallel with and along the electrode terminal and with conductive linking member of each battery module, the electrode terminals, release a large amount of heat from inside the battery modules, and the conductive linking members are effectively cooled. In addition, because it is possible to cool the outer peripheral surface of every battery module by the flow of cooling medium in the first cooling medium flow path and by the flow of cooling medium in the second cooling medium flow path, more effective cooling of the battery modules within the enclosure becomes possible. The result is that miniaturization of the entire unit becomes possible.

(2) It may be arranged such that: the first cooling medium flow path is provided in a region of the enclosure near a first end in the axial direction of the battery module; and a cooling medium intake opening is provided which communicates with the second cooling medium flow path, in a region of the enclosure near a second end in the axial direction of the battery module.

In this case, the cooling medium which is introduced from the cooling medium feed port of the enclosure flows through the second cooling medium flow path into the first cooling medium flow path, cooling the outer peripheral surface of each battery module.

Moreover, in this way, while having an extremely simple construction, it is possible to flow cooling medium reliably in the second cooling medium flow path. Consequently, it is possible to further miniaturize the unit and to reduce manufacturing costs.

(3) It may be arranged such that: the battery container unit according to claim 2, wherein the conductive linking member includes: a plurality of first conductive linking members each of which links an adjacent pair of the electrode terminals along the flow direction of the cooling medium within the first cooling medium flow path; and a second conductive linking member which is provided across extensions of respective linking lines of two adjacent first conductive linking members, and connects a pair of the electrode terminals in the direction intersecting with the flow direction of the cooling medium.

In this case, the heat release region of the first conductive linking member and the second conductive linking member do not overlap in the flow direction of the cooling medium.

Consequently, the plurality of battery modules within the enclosure is uniformly and effectively cooled while miniaturizing the entire unit.

(4) It may be arranged such that: the battery container unit further includes a bent cooling medium separator which divides a first cooling medium sub-passage passing along the first conductive linking member and a second cooling medium sub-passage passing along the second conductive linking member.

In this case, the region of the cooling medium passage along the first conductive linking member and the passage along the second conductive linking member are separated as respective dedicated cooling passages by the cooling medium separator.

That is, the flow in the cooling medium flow path is completely separated by the cooling medium separator into the flow which passes along the first conductive linking member and the flow which passes along the second conductive linking member. Because of this partition, the conductive linking member downstream is not affected by the heat from the conductive linking member upstream. In addition, it is possible to maintain space insulating destructive separation for opposite polarity combinations by the cooling medium separator.

(5) It may be arranged such that: the cooling medium separator is formed on a wall within the enclosure facing the first conductive linking member and the second conductive linking member.

In this case, because the cooling medium separator is formed on a wall of the enclosure, it is possible to reduce manufacturing costs by simplifying the construction.

(6) It may be arranged such that: two of the first cooling medium flow paths are provided near the first end and the second end respectively in the axial direction of the battery module of the enclosure.

In this case, both sides of the electrode terminal and the conductive linking member of each battery module are respectively cooled by the cooling medium which flows in the first cooling medium flow paths. In addition, in the second cooling medium flow path, the cooling medium flows towards both of the first cooling medium flow paths from the center of the axial direction of the battery module. In this way, more effective cooling of both sides of the electrode terminal and the conductive linking member of every battery module, which releases a large amount of heat, is possible.

(7) It may be arranged such that, in the battery container unit of (6): the conductive linking member includes: a plurality of first conductive linking members each of which links an adjacent pair of the electrode terminals along the flow direction of the cooling medium within the first cooling medium flow path; and a second conductive linking member which is provided across extensions of respective linking lines of two adjacent first conductive linking members, and connects a pair of the electrode terminals in the direction intersecting with the flow direction of the cooling medium.
(8) It may be arranged such that, in the battery container unit of (7): the battery container unit further includes a bent cooling medium separator which divides a first cooling medium sub-passage passing along the first conductive linking member and a second cooling medium sub-passage passing along the second conductive linking member.
(9) It may be arranged such that, in the battery container unit of (8): the cooling medium separator is formed on a wall within the enclosure facing the first conductive linking member and the second conductive linking member.
(10) It may be arranged such that: the battery container unit further includes a flow accelerator, which locally enhances the flow speed of the cooling medium, provided within the first cooling medium flow path in the enclosure.

In this case, when the cooling medium is flowing in the first cooling medium flow path, the flow accelerator locally increases the flow speed of the cooling medium. At this time, the negative pressure near the flow accelerator generates turbulence within the first cooling medium flow path. The turbulence induces flow of the cooling medium in the second cooling medium flow path.

Because it is possible to generate flow of cooling medium more effectively in the second cooling medium flow path by the flow accelerator, which was provided within the first cooling medium flow path, it becomes possible to enhance the cooling efficiency on the outer peripheral surface of each battery module.

(11) It may be arranged such that: the flow accelerator includes a protrusion protruding from the enclosure along the axial direction of the battery module and facing the conductive linking member.

In this case, because the flow accelerator is formed by the protrusion provided in the enclosure, it is possible to reduce manufacturing costs by simplifying the construction.

### BRIEF DESCRIPTION OF THE DRAWINGS

FIG. 1 is a cross-section according to a first embodiment of this invention, corresponding to the A-A cross-section of FIG. 2.

FIG. 2 is an end view of a battery container unit according to the same embodiment which has removed the second cover.

FIG. 3 is a perspective view of the battery module according to the same embodiment.

FIG. 4 is a characteristics diagram showing temperature changes at the center of the battery module when performing cooling and when not performing cooling at the electrode terminal.

FIG. 5 is a characteristics diagram showing the relationship of the size of the terminal coupling part, the flow path of the cooling medium and the cooling capability.

FIG. 6 is a vertical cross-section showing a second embodiment of this invention.

FIG. 7 is an end view corresponding to FIG. 2 showing a third embodiment of this invention.

FIG. 8 is a cross-section according to a fourth embodiment of this invention corresponding to the D-D cross-section of FIG. 10.

FIG. 9 is a plan view of the battery container unit with the cover off according to the same embodiment.

FIG. 10 is a partial sectional view according to the same embodiment.

FIG. 11 is a perspective view with a plurality of arranged battery modules according to the same embodiment.

FIG. 12 is a characteristics diagram showing temperature changes at the center of the battery module when performing cooling and when not performing cooling at the electrode terminal.

FIG. 13 is a characteristics diagram showing the relationship of the size of the terminal fastening part, the flow path of the cooling medium and the cooling capability.

FIG. 14 is a cross-section of the same form as FIG. 8, according to a fifth embodiment of this invention.

### DETAILED DESCRIPTION OF THE INVENTION

Below, an explanation is given, based on the drawings, of each embodiment of this invention. Moreover, for the explanation of every embodiment below, the same part has been given the same symbol and explanations are omitted for duplicated parts.

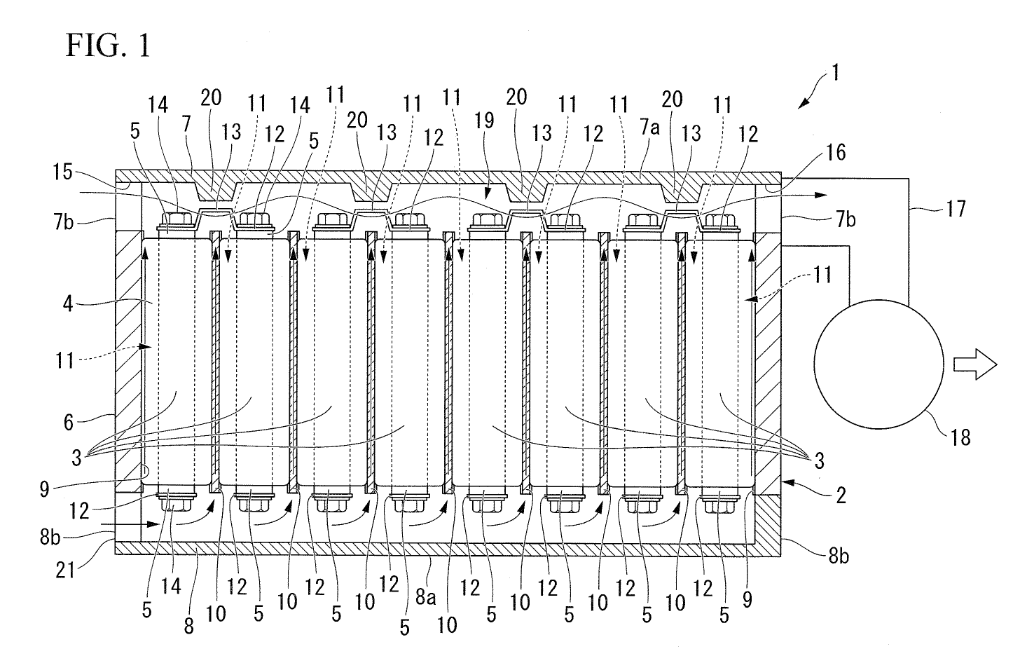

Initially, by referencing FIGS. 1 to 3, an explanation is given for the first embodiment of this invention.

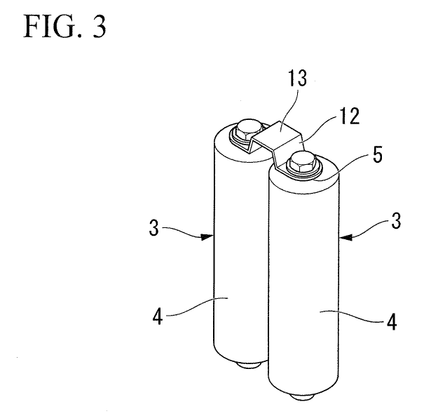

The battery container unit 1 of this embodiment is used as the driving electric source of electric cars which include hybrid cars. The plurality of battery modules 3 are provided in parallel and stored within the nearly rectangular parallelepiped metal enclosure 2. The module main body 4 is formed, as shown in FIG. 3, as cylinder-shaped in the battery module 3, and every one of the positive and negative electrode terminals is provided on both surfaces in the axial direction of this module main body 4. Moreover, in this specification, the battery module, in addition to being formed as a cylindrical shape by serially connecting a plurality of single batteries, includes also the case of a cylinder-shaped single battery unit.

The enclosure 2 includes the rectangular-shaped enclosure main body 6 with an opening provided at the ends of both opposing sides and a first cover 7 and a second cover 8 which covers the openings on both sides of the enclosure main body 6.

Both the cover 7 and 8 are integrated by bolt coupling of the enclosure main body 6.

Here, for the convenience of explanation, “opening direction” is the direction linking both openings of the enclosure main body 6. A plurality of support walls 9 along the opening direction is formed as one body on the inner wall of the enclosure main body 6. The battery modules 3 are supported by every support wall 9.

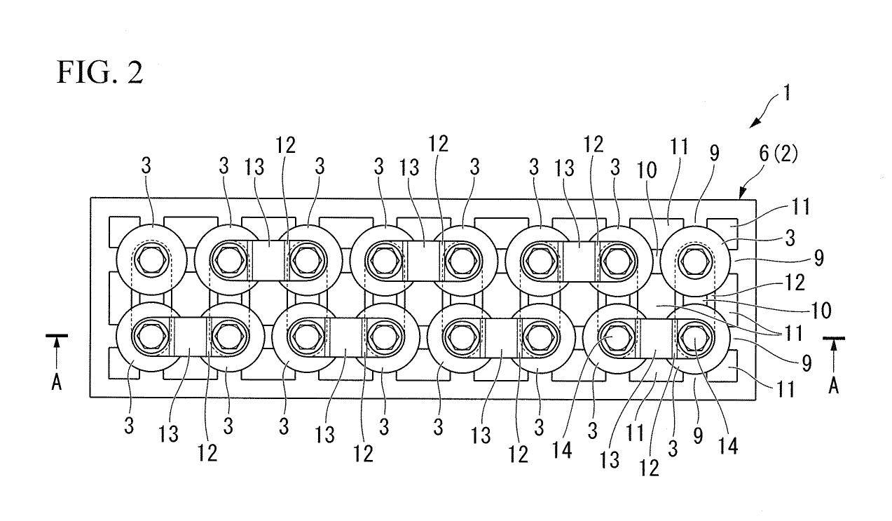

The plurality of battery modules 3 is arranged in parallel within the enclosure main body 6 so as to cause the axial direction of every battery module 3 to be along the direction of the opening of the enclosure main body 6. As shown in FIG. 2, when seen from the opening direction, the entire body is placed in matrix form so as to be correctly adjusted as two-stage and aligned. In the case of this example of the embodiment, the plurality of battery modules 3 is arranged in 2 stages of 8 columns. The support member 10 which runs along the opening direction of the enclosure main body 6 is inserted between adjacent battery modules of every stage and column. Consequently, on the inside of the enclosure main body 6, as shown in FIG. 2, a plurality of battery modules 3 are arranged in a grid along with the previously mentioned plurality of support walls 9 and support member 10.

Here, the surface which connects the outer peripheral surface of the battery module 3 of each support walls 9 and support member 10 is formed in a circular arc shape lying along the outer peripheral surface of the same battery module 3. The boundary of each battery module 3 is partitioned into 4 spaces which extend in the axial direction of the battery module 3 by the support member 10 or the support wall 9. This plurality of demarcated spaces forms the later described second cooling medium flow path 11.

In addition, the electrodes of the plurality of battery modules 3, which are placed inside of the enclosure main body 6, as previously described, are arranged so that opposite (positive and negative) electrodes come next to each other. Adjacent pairs of electrode terminals 5 are linked by the bus bar 12 which is a conductive linking member. All the battery modules 3 within the enclosure main body 6 are serially connected by the linking of the plurality of electrode terminals 5 by this bus bar 12.

The bus bar 12 is formed in a cross-sectional hat shape by conductive metal plates. The edge parts placed both sides of the center step-shaped bent convex part 13 are each connected by the screw to the end surface of respective electrode terminals 5. Moreover, the bus bar 12 is joined to each electrode terminal 5 so that the bent convex part 13 protrudes to the outside in the axial direction of the battery module 3.

At the same time, the first cover 7 has a ceiling wall 7a which corresponds to the form of the terminal surface of the enclosure main body 6 and 4 faces of side walls 7b which corresponds to the peripheral wall of the enclosure main body 6. Within the 4 faces of side walls 7b, the feed port 15 and discharge port 16 for cooling air (cooling medium) are respectively formed on one side wall 7b which meets a narrow side of the first cover 7 and another side wall 7b on the opposite side. The intake duct 17 is connected to the discharge port 16 of this first cover 7. An intake fan 18, for sucking air from within the enclosure 2, is connected to this intake duct 17. The feed port 15 and the discharge port 16 are provided at opposing positions on side walls 7b. When intake of air by the intake fan 18 begins, the air that is taken from the feed port 15 progresses within the enclosure linearly in the direction to the discharge port 16, and by passing through the discharge port 16 and intake duct 17, the air is taken into the intake fan 18. This flow path within the first cover 7 which connects linearly with the feed port 15 and discharge port 16 forms the first cooling medium flow path 19 for this invention. This first cooling medium flow path 19 adjoins the electrode terminals 5 and bus bars 12 at one end side in the axial direction of the plurality of battery modules placed in the enclosure main body 6.

In addition, a plurality of protrusions 20 which face the first cooling medium flow path 19 is formed on the ceiling wall 7a of the first cover 7. These protrusions 20, on the ceiling wall 7a, are provided on the part opposite each bus bar 12, which faces the first cooling medium flow path 19. The peak of each protrusion 20 faces the bent convex part 13 of the bus bar 12. The flow of cooling air which passes through the first cooling medium flow path 19 is locally squeezed by the gap between both facing protrusions. Moreover, for this embodiment, the protrusion 20 forms a flow accelerator section which increases the speed of the cooling air.

In addition, the second cover 8 has a ceiling wall 8a corresponding to the form of the end surface of the enclosure main body 6 and 4 faces of side walls 8b which corresponds to the peripheral walls of the enclosure main body 6. An intake opening 21 (cooling medium intake opening) is formed for taking cooling air externally for one within the side walls 8b. The air that is taken in from this intake opening 21 is presented to the first cooling medium flow path 19 by passing through each second cooling medium flow path 11 along the axial direction of the plurality of battery modules within the enclosure main body 6.

Moreover, an appropriate intake opening 21 may be provided on the ceiling wall 8a of the second cover 8. Within the ceiling wall 8a, the intake opening 21 may be provided at a position corresponding to the electrode terminal 5 and the bus bar 12, and in this case of construction, cooling of the electrode terminal 5 and bus bar 12 are more efficiently performed.

When using the battery container unit 1 with the above described structure, if the intake fan 18 is driving, cooling air which was taken form the feed port 15 of the enclosure 2 progresses linearly to the first cooling medium flow path 19 and is taken in by the intake duct 17. Along with this flow, negative pressure is generated on one end of the second cooling medium flow path 11 by the flow of cooling air which flows in the first cooling medium flow path 19. By this negative pressure, cooling air which is taken in from the take in intake opening 21 passes through the second cooling medium flow path 11 and is taken up by the first cooling medium flow path 19. At this time, the electrode terminal 5 and the bus bar 12 at one side of each battery module 3 are cooled by the cooling air which linearly flows in the first cooling medium flow path 19. Along with this cooling, the outer peripheral surface of each battery module 3 is cooled by the cooling air flowing in the second cooling medium flow path 11.

The cooling air in this battery container unit 1 flowing in the first cooling medium flow path 19 flows linearly along and in parallel with the plurality of electrode terminal 5 and with the plurality of bus bars 12 in the plurality of battery modules 3 within the enclosure 2. Because of this flow, it is possible to efficiently cool, using a large amount of cooling air, the electrode terminals 5 and bus bars 12 which are directly connected, by material with high thermal conductivity, to the heat generating section of each battery module. In addition, the cooling air also flows through the second cooling medium flow path 11 on the peripheral surface of each battery module while the flow amount is smaller compared with the first cooling medium flow path 19. Because the cooling air flows in this way, it is possible to prevent heat accumulation in the enclosure 2.

Consequently, in this battery container unit 1, it is possible to effectively cool the plurality of battery modules within the enclosure 2, without using cooling medium flow paths of excessively large surface areas in the outer peripheral region for the plurality of battery modules 3. As a result, it is possible to miniaturize the entire unit while maintaining sufficient cooling performance.

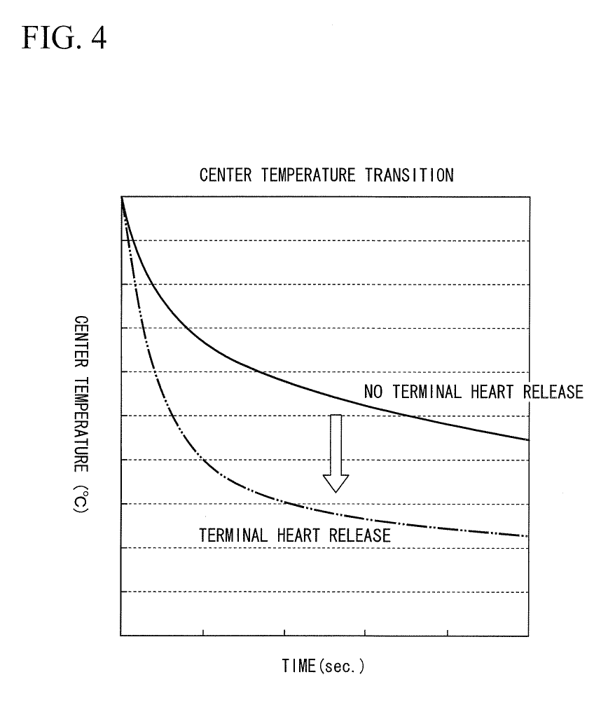

FIG. 4 shows the results of investigating the temperature changes at the center of the battery modules 3, when cooling electrode terminals 5 in the present embodiment and when not cooling the electrode terminals 5. As is clear from FIG. 4, when cooling the electrode terminals 5, it is possible to quickly reduce the temperature at the center of the battery modules 3.

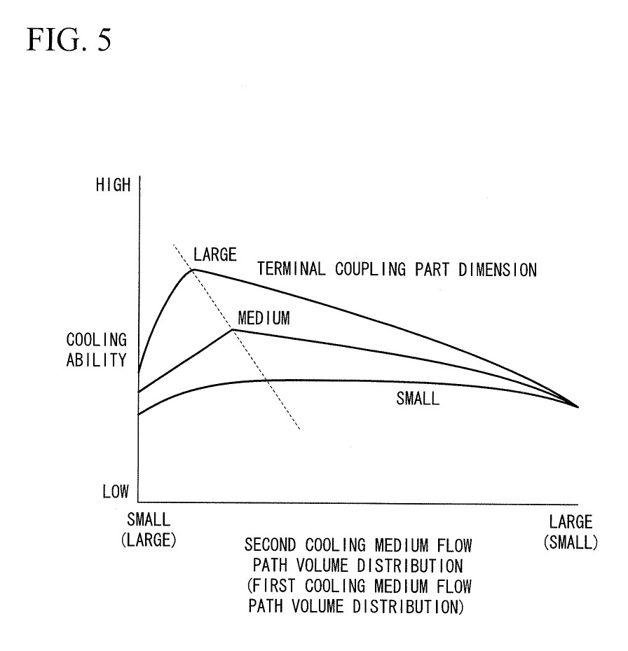

In addition, FIG. 5 shows the results comparing the relationships of the volume distribution of the cooling medium and the cooling ability, in the first cooling medium flow path and second cooling medium flow path, in the cases of different terminal coupling part dimensions, that is, for each size of the electrode terminals 5. As is clear from the same figure, when cooling the electrode terminals 5, the volume distribution towards the first cooling medium flow path, in contrast to that of the second cooling medium flow path, is suitable. In addition, it is also suitable to increase the cooling ability for the electrode terminal 5 when the terminal coupling part dimension is large.

Consequently, with this embodiment, by way of making the size of the bus bar 12 large by providing the bent convex part 13, facing the first cooling medium flow path 19, it becomes advantageous for improving the cooling efficiency of the battery modules 3.

In addition, the protrusion 20, facing the peak of the bus bar 12, is provided on the first cover 7 of the enclosure 2, in the present embodiment's battery container unit 1. The flow of cooling air passing within the first cooling medium flow path 19 is narrowed at the gap between the bus bar 12 and the protrusion 20. Because of this narrowing, it is possible to efficiently take in the cooling air from the first cooling medium flow path 19 to the second cooling medium flow path 11 by the effect of the turbulence generated around this narrowing part. Consequently, it is possible to arrange the gap between adjacent battery modules 3 narrower without limiting the air flow. Because of this ability, it is advantageous to additionally miniaturize the entire unit. Especially, in the present embodiment, since the construction is a simple, merely forming the protrusion 20 on the first cover 7, it is possible to reduce the manufacturing costs.

In the present embodiment of the battery container unit 1, the constitution is adopted wherein the first cooling medium flow path 19 is provided only in a region on one side in the axial direction of the plurality of battery modules 3 within the enclosure 2, and the intake opening 21 is provided only on the other side of the enclosure 2. In this constitution, miniaturization of the entire unit and a reduction in manufacturing costs can be achieved, while maintaining sufficient cooling ability for the plurality of battery modules 3.

On the other hand, the first cooling medium flow path 19 can be provided on both sides in the axial direction of the plurality of battery modules 3 within the enclosure 2.

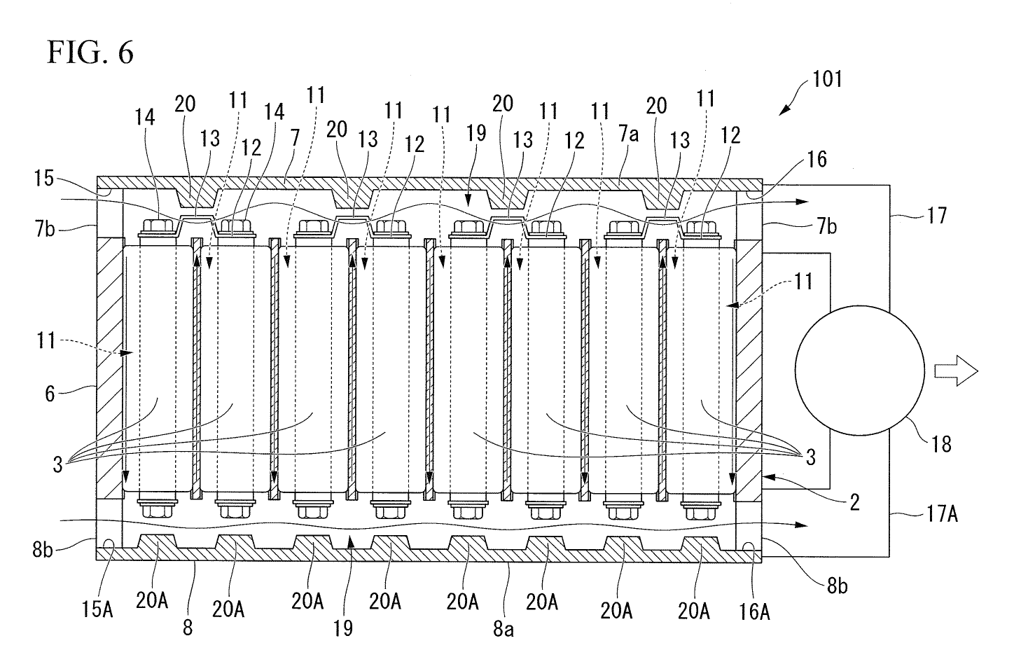

FIG. 6 shows a second embodiment of this invention, having provided the first cooling medium flow path 19 on both sides in the axial direction of the plurality of battery modules 3 within the enclosure 2.

In the battery container unit 101, another feed port 15A and another discharge port 16A are provided on the side walls 8b of the second cover 8, as in the first cover 7. The plurality of bus bars 12 is provided so as to connect the electrode terminals 5 of the other end (referred to as second end) in the axial direction of the plurality of battery modules. FIG. 6 does not show the bus bars 12 of the second end, but in FIG. 2, bus bars 12 of the second end are shown by dotted lines. Another first cooling medium flow path 19 is formed in parallel and along these plurality of bus bars 12 of second ends. The discharge port 16A connects to the intake fan by the intake duct 17A. In addition, the protrusions 20A are formed on the ceiling wall 8a of the second cover 8, so as to face each bent convex part 13 (not illustrated) of the bus bar 12 of the second end. Narrowing of the flow path is obtained by the gaps between the protrusions 20A and the bus bars 12.

When the intake fan 18 is operating for the battery container unit 101, cooling air flows into two of the first cooling medium flow paths 19 within the enclosure 2. At this time, a negative pressure is generated on the parts where the protrusions 20 and protrusions 20A are formed within the second cooling medium flow path 11 by the flow of cooling air for each first cooling medium flow path 19. The cooling air flows toward the other end from any end of the second cooling medium flow path 11 along the axial direction of the second cooling medium flow path 11, as a result of the negative pressure, and the air is taken in to the first cooling medium flow path 19. The flow of cooling air towards each first cooling medium flow path 19 from this second cooling medium flow path 11 is promoted by the turbulence generated around the protrusions 20 and 20A in the first cooling medium flow paths 19.

Consequently, with this battery container unit 101, because the electrode terminals 5 and bus bars 12 on both sides in the axial direction of the battery modules 3 within the enclosure 2 are linearly cooled by the first cooling medium flow path 19, which is placed on both of the respective sides, it is possible to efficiently cool each battery module 3.

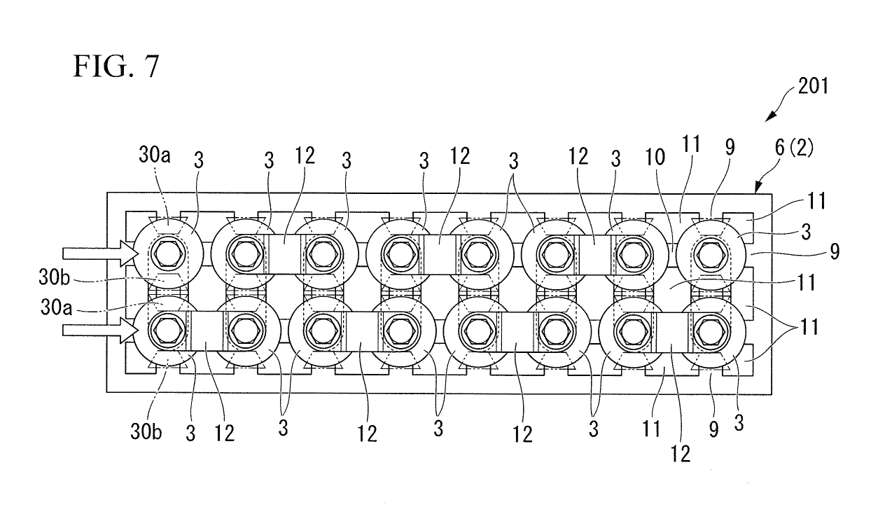

Moreover, this invention is not limited to the embodiments, and various design changes are possible without departing from the spirit and scope of the invention. For example, the previously described embodiments assume a flow accelerator by forming a protrusion 20 facing the bus bar on the first cover 7 or second cover 8. On the other hand, as shown in FIG. 7, in the battery container unit 201 of a third embodiment, flow accelerators may be formed by protrusions 30a and 30b which form a pair, by establishing on the first or second covers pairs of mutually facing protrusions 30a and 30b, having a predetermined gaps. In addition, for each embodiment described above, the intake fan 18 is connected to the discharge port 16 of the first cooling medium flow path 19, but instead, a pressure feed device of cooling air may be connected to the feed port 15 of the first cooling medium flow path 19.

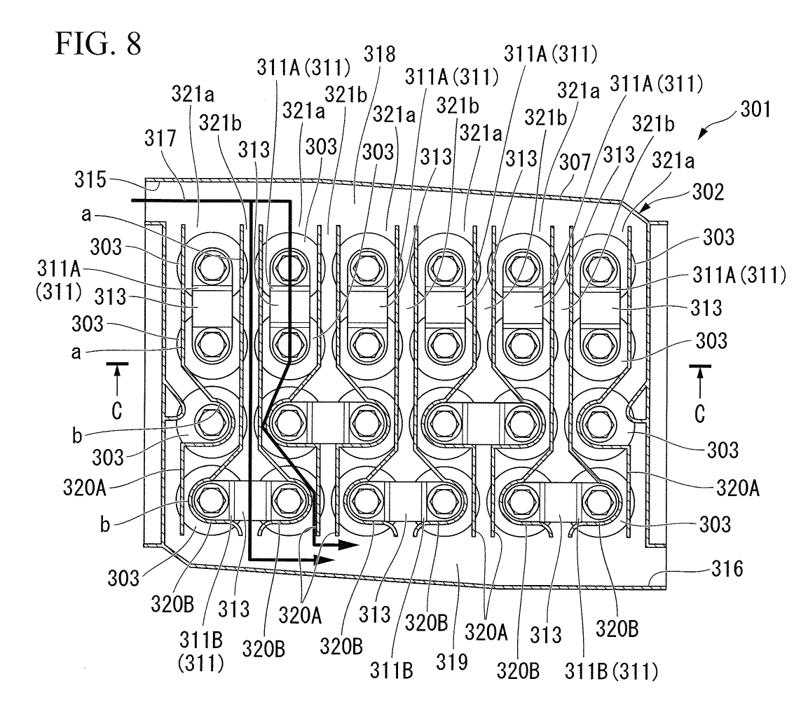

Below, an explanation is given for still further embodiments of this invention, by referring to FIGS. 8 to 14. Moreover, in the explanation of each embodiment that follows, the same symbols are assigned to the corresponding parts, and explanations of duplicated parts are omitted.

Initially, as shown in FIGS. 8 to 11, an explanation is given a the fourth embodiment of this invention.

The battery container unit 301 of this embodiment is used as a driving electric source for electric car which include hybrid cars, and a plurality of battery modules 303 are arranged in parallel and housed within the nearly rectangular parallelepiped metal enclosure 302. The module main body 304 is cylindrically formed, as shown in FIG. 11, for the battery module 303, and each one of the positive and negative electrode terminals 305 is provided on both ends in the axial direction of this module main body 304. Moreover, this specification, in addition to forming the battery module to a cylindrical shape, serially connects a plurality of single batteries, including the case of a cylindrical single battery single shape.

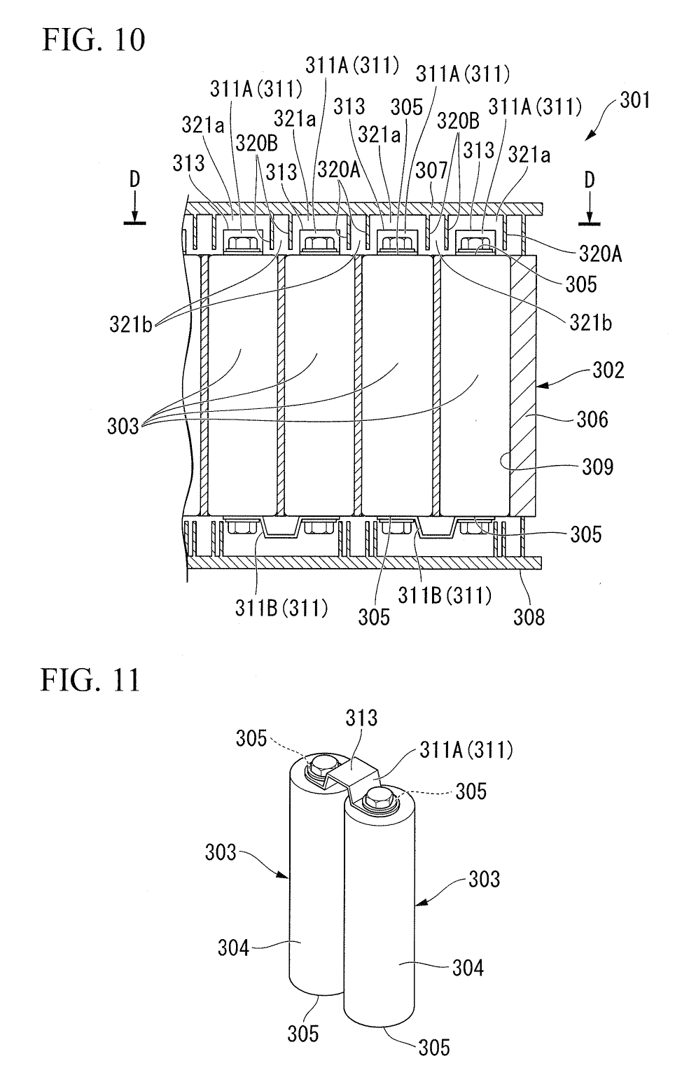

The enclosure 302 includes, as shown in FIG. 10, the rectangular shaped enclosure main body 306 with openings provided on the ends of both opposing sides, and a first cover 307 and a second cover 308 which cover the opening on both sides of the enclosure main body 306. Both covers 307 and 308 are integrated as one body by bolt coupling to the enclosure main body 306.

Below, for the convenience of explanation, the “opening direction” is defined as the direction linking the openings on both sides of the enclosure main body 306. A plurality of support walls along the opening direction is formed as one unit. The battery module 303 is supported by each support wall 309.

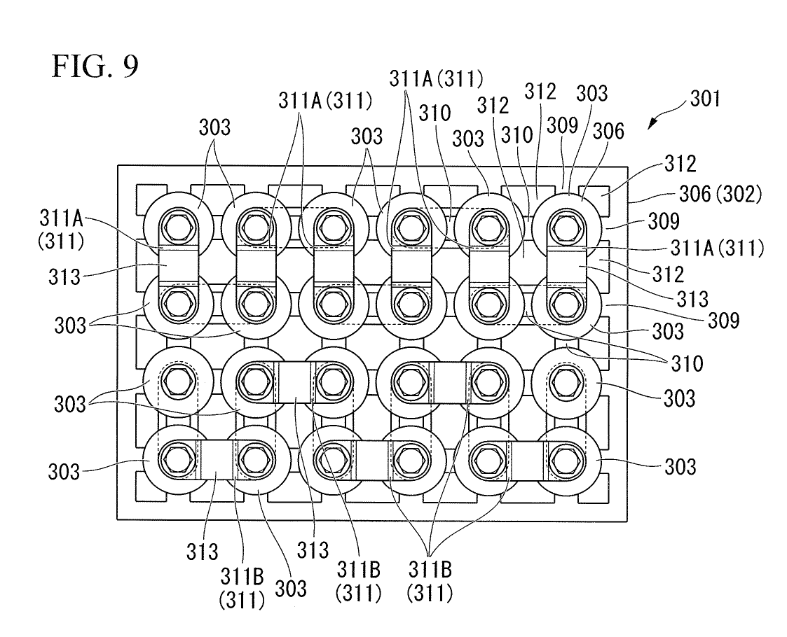

The plurality of battery modules 303 is arranged in parallel within the enclosure main body 306 by making the axial direction of every battery module 303 along the opening direction of the enclosure main body 306. As shown in FIG. 9, when seen from the opening direction, the entire body is arranged in a matrix-shape so that the parts are aligned in a uniformed manner along the rows and columns. The battery module for an example of this embodiment is arranged in 4 stages of 6 columns. Moreover, below, when explaining the arrangement of the battery module 303, the up-down directions correspond to those in the FIG. 8 are used, as in “upper 2 stages” and “lower 2 stages”.

Between each stage and each column of adjacent battery modules 303, a support member is interposed, extending along the opening direction of the enclosure main body 306. Consequently, inside the enclosure main body 306, as shown in FIG. 9, the plurality of battery modules 303 is arranged in a grid along with the already described plurality of support walls 309 and support members 310.

Here, the face making contact with the outer peripheral surface of the battery module 303 of each support wall 309 and support member 310 is formed as a circular arc along the outer peripheral surface of the battery module 303. The boundary of each battery module 303 is demarcated into 4 spaces 312 which are extended in the axial direction, by the support member 310 and support wall 309.

In addition, the plurality of battery modules 303 arranged inside of the enclosure main body 306, as previously described, is set so that the adjacent pairs of electrodes have opposite polarities, and the adjacent electrode terminals 305 are linked to the bus bar 311, which is a conductive linking member. The linkage of the electrode terminals 305 by this bus bar 311 is arranged so that all of the battery modules 303 of upper 2 stages within the enclosure main body 306 and all of the battery modules 303 of lower 2 stages are respectively serially connected.

The bus bar 311 is formed in a cross-sectional hat-shape by a conductive metal plate. The edges at the both sides of the center step-shaped bent convex part 313 is joined by the screw 314 on the end of the respective electrode terminals 305. Moreover, the bus bar 311 is joined to each electrode terminal 305 by protruding the bent convex part 313 to the outside of the axial direction of the battery module 303. This bent convex part 313 is a heat release region which releases the most part of the heat of the electrode terminals 305 to the outside.

At the same time, the first cover 307 has a ceiling wall corresponding to the form of the terminal of the enclosure main body 306 and 4 faces of the side wall which correspond to the peripheral wall of the enclosure main body 306. Within the 4 faces of the side wall, the feed port 315 for cooling air and the discharge port 316 are respectively formed on one side wall adjacent to the narrow side of the first cover 307 and on the other side wall facing the first face. As shown in FIG. 8, the feed port 315 is arranged asymmetrically, at a position close to one side in the width direction of one of the side walls, and the discharge port 316 is arranged asymmetrically on the other side in the width direction of the other side wall. Between feed port 315 and discharge port 316 within the enclosure 302, a cooling medium flow path 317 is formed in which cooling air flows. For this embodiment, an intake fan (not illustrated) is connected to the discharge port 316 by an intake duct (not illustrated). By driving this intake fan, cooling air which flowed in from the feed port 315 is discharged to the outside of the enclosure 302 by passing through the cooling medium flow path 317 and the discharge port 316. The cooling medium flow path 317 is constructed principally within the space surrounded by the side walls of the first cover 307. At the same time, the electrode terminal 305 and bus bar 311 of the plurality of the battery modules 303, which are supported by the enclosure main body 306, are made to face the cooling medium flow path 317 by protruding within this space.

Under the conditions when the first cover 307 is mounted to the enclosure main body 306, within the enclosure 302, as shown in FIG. 8, the feed side translation passage 318, extending straight from the feed port 315, is formed. Parallel to this feed side translation passage 318, the exhaust side translation passage 319 is formed, extending linearly in the direction of the discharge port 316. The cooling air, which is fed to the enclosure 302, principally flows by changing the passage to about 90° in the direction toward the exhaust side translation passage 319 from the feed side translation passage 318.

For this embodiment, the plurality of bus bars 311, which connect adjacent battery modules on the first cover 307 side, is arranged as follows.

That is, all the bus bars 311, which correspond to the battery modules 303 of the upper 2 stages, are arranged along the entire flow of the cooling air in the direction toward the exhaust side translation passage 319 from the feed side translation passage 318, and link pairs of battery modules 303, which are adjacently arranged along the flow direction of the cooling air. Hereinafter, these bus bars are called “first bus bars 311A (first conductive linking members).” In addition, the bus bars 311 which correspond to the lower 2 stages of battery modules 303 are arranged in a direction perpendicular to all the flow of cooling air, and connect by linking the pairs of battery modules which are adjacently arranged in a direction perpendicular to the flow of the cooling air. Hereinafter, these bus bars are called “second bus bars 311B (second conductive linking member).” The second bus bars 311B arranged on the upper stage (the third stage from the top) among the lower 2 stages are offset in a direction perpendicular to the flow of cooling air with respect to the second bus bars 311B which are arranged within the lower stage (the fourth stage from the top) among the lower 2 stages.

Consequently, for the bus bars 311 which connect the battery modules 303 of the upper 2 stages and the second bus bars 311B which connect the battery modules 303 of the lower 2 stages, respective bent convex parts 313 do not overlap in the direction of flow of the cooling air.

In addition, the plurality of partitioning walls 320A and 320B (cooling medium separator) which extend in the direction toward the exhaust side translation passage 319 from the feed side translation passage 318 are provided protruding from the ceiling wall of the first cover 307. Each partitioning wall 320A and 320B includes a linear region a in the longitudinal direction of the first bus bar 311A and a bent region b which wraps around the end of the second bus bar 311B, bending from the linear region a. The plurality of adjacent partitioning walls 320A and 320B cooperate, forming a plurality of discriminating passages 321a and 321b (cooling medium sub-passage). The cooling air enters from the feed side translation passage 318 and flows through either of the discriminating passages 321a or 321b. The respective discriminating passages pass through only one of the bus bars 311A or 311B.

Up to here, the explanation has been for the structure of the first cover 307. A similar structure to the first cover 307 is adopted also for the second cover 308. A detailed explanation for the second cover 308 is omitted. In the second cover 308, the second bus bars 311B are arranged on the upper 2 stages, and the first bus bars 311A are arranged on the lower 2 stages, in order to connect the battery modules 303 serially.

For the previously described structure, when the intake fan is being driven for the use of the battery container unit 301, cooling air which flowed into the feed side translation passage 318 from the feed port 315 of the enclosure 302 passes through the plurality of discriminating passage 321a and 321b from the feed side translation passage 318, flowing towards the exhaust side translation passage 319 and is exhausted to the outside of the enclosure 302 by passing through the discharge port 316. At this time, the cooling air passing through each discriminating passage 321a and 321b is exhausted to the outside after cooling only one each of the bent convex parts 313 and electrode terminals 305 of the corresponding bus bars 311A or 311B.

For this battery container unit 301, the cooling air which flows through the cooling medium flow path 317 flows to the electrode terminals 305 and to bus bars 311A and 311B of the plurality of battery modules 303 within the enclosure 302. Because of this flow, it is possible to efficiently cool by cooling air the electrode terminals 305 and the bus bars 311 which are directly connected by high thermal conductivity material in the heat generating section of each battery module 303. In addition, when comparing with the cooling medium flow path 317, with a small flow amount, cooling air flows to the outer peripheral surface of each battery module 303 by passing through the boundary spaces 312. Because of this flow, it is possible to efficiently prevent a build-up of heat within the enclosure 302.

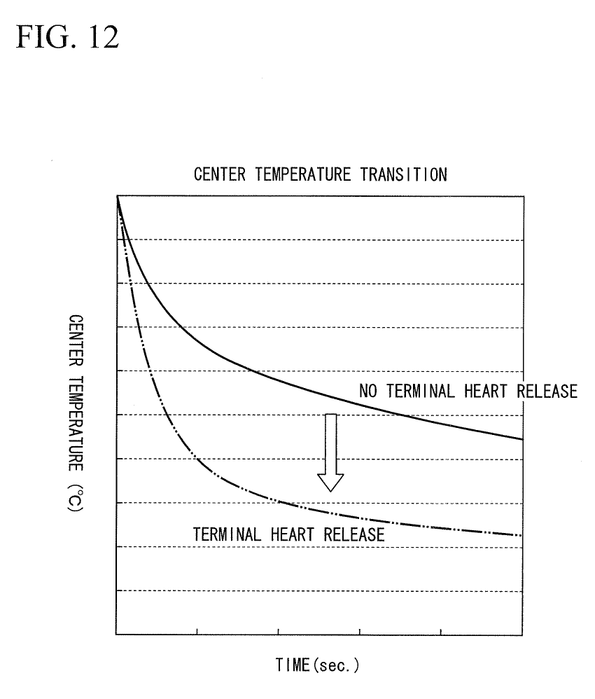

FIG. 12 shows the results of investigating temperature changes at the center of the battery module 303, when cooling the electrode terminal 305 as with this embodiment and when not cooling the electrode terminal 305. As is clear from the same figure, when cooling the electrode terminal 305, it is possible to quickly reduce the temperature at the center of the battery module 303.

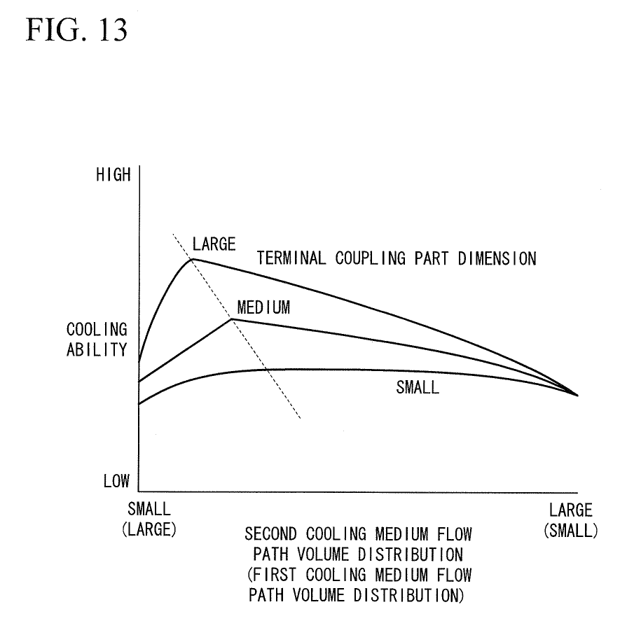

In addition, FIG. 13 shows, when cooling the electrode terminal 305, the results of comparing for each terminal, coupling dimension, that is, the size of the electrode terminal 305, the relationship of volume of distribution and the cooling ability of the cooling medium towards the flow path (second cooling medium flow path) which passes through the flow path (first cooling medium flow path) and then passes through the electrode terminal 305 and the outer periphery of the battery module 303. As is clear from the same figure, when cooling the electrode terminal 305, as the volume distribution towards the first cooling medium flow path, in contrast to the second cooling medium flow path, becomes is large, and as the terminal coupling part dimension becomes large, it is possible to further improve the cooling ability for an electrode terminal 305.

Accordingly, in this embodiment, making the size large by establishing a bent convex part 313 on the bus bars 311A and 311B which face the cooling medium flow path 317 becomes advantageous in enhancing the cooling efficiency for the battery module 303.

In addition, for this battery container unit 301, along with the first bus bars 311 being arranged in parallel in the direction of the flow of cooling air, the second bus bars 311B, which are downstream or upstream with respect to the first bus bars 311, are arranged perpendicular to the flow direction of the cooling air. Because the bent convex part 313 of the first bus bar 311A and the bent convex part 313 of the second bus bar 311B do not overlap in the flow direction of the cooling medium, the heat released from one bus bar 311A (311B) does not affect the cooling of the other bus bar 311B (311A). More specifically, because the second bus bar 311B of each stage is arranged with an offset, the bent convex parts 313 of the two second bus bars 311B, does not overlapping in the flow direction of the cooling medium, do not affect the release of heat. Consequently, because this battery container unit 301 can uniformly and efficiently cool the plurality of battery modules 303 within the enclosure 302, further miniaturization of the entire unit is possible.

Furthermore, in this battery container unit 301, the cooling medium flow path 317 within the enclosure 302 is partitioned into the plurality of discriminating passages 321a and 312b by the plurality of partitioning walls 320A and 320B so that one of the passages corresponds to only one of the bus bars 311A (311B). Because of this partitioning, it is possible to more uniformly cool the bus bars 311A and 311B and the electrode terminals 305 within the enclosure 302. This battery container unit 301 has the advantage of being able to sufficient distance between electrodes of opposite polarity, in order to prevent insulation breakdown, because the cooling medium flow path 317 is partitioned into a plurality of discriminating passages 321a and 321b, corresponding to each bus bar 311A and 311B.

Furthermore, with this embodiment, the discriminating walls 320A and 320B protrude from the ceiling wall of the first and second covers 307 and 308 facing the bus bars 311A and 311B, forming the discriminating passages 321a and 321b. This simplification in construction can lead to a reduction in manufacturing costs.

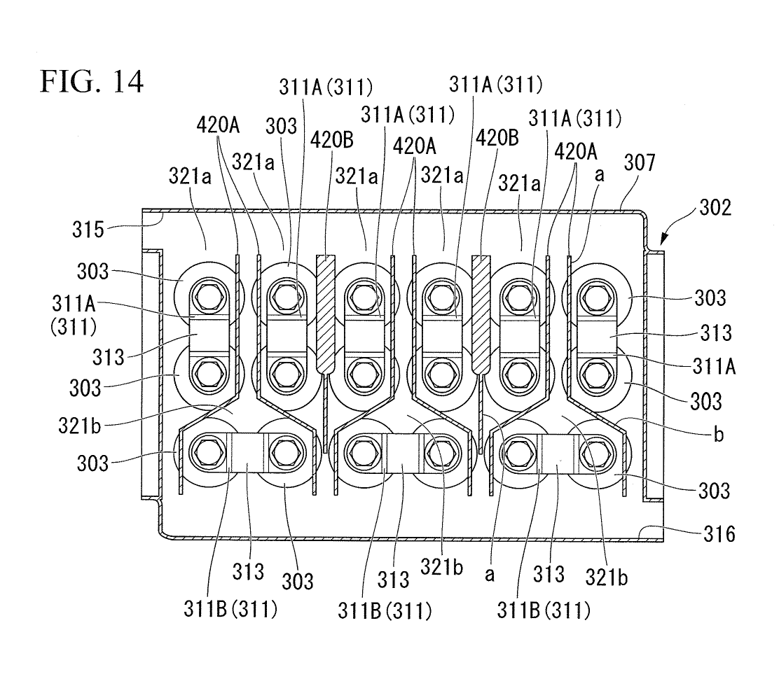

Moreover, this invention is not limited to the previously described embodiments and various design changes are possible without departing from the spirit and scope of the invention. For example, the fourth embodiment has battery modules 303 arranged in 4 stages of 8 columns within the enclosure 302. However, this arrangement of the battery modules is not limited to 4 stages of 8 columns. The battery modules 303 may be arranged in 3 stages as in a fifth embodiment shown in FIG. 14. In this case, the arrangement having a linear region a and bent region b and an arrangement of only a linear region b can be used for the partitioning walls 420A and 420B.

In addition, with the previously described embodiments, the intake fan is connected to the discharge port 316 of the enclosure 302, but the pressure feed device for cooling air may be connected to the feed port 315 of the enclosure 302.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and it only limited by the scope of the appended claims.

What is claimed is:

1. A battery container unit comprising:
an enclosure; and
a plurality of battery modules of cylindrical shape, arranged in parallel within the enclosure, each having an electrode terminal at an end in the axial direction, wherein
each adjacent pair of the electrode terminals is serially connected by a conductive linking member,
the plurality of battery modules are provided in matrix form within the enclosure by a support member,
a first cooling medium flow path is provided which linearly flows a cooling medium along in parallel with the electrode terminals and the conductive linking members of the plurality of battery modules in a region within the enclosure near an end in the axial direction of the plurality of battery modules, and
a second cooling medium flow path is provided in a gap along the axial direction of the battery modules, between adjacent battery modules within the enclosure, which flows the cooling medium toward the first cooling medium flow path.

2. The battery container unit according to claim 1, wherein:
the first cooling medium flow path is provided in a region of the enclosure near a first end in the axial direction of the battery module;
and a cooling medium intake opening is provided which communicates with the second cooling medium flow path, in a region of the enclosure near a second end in the axial direction of the battery module.

3. The battery container unit according to claim 2, wherein the conductive linking member includes:
a plurality of first conductive linking members each of which links an adjacent pair of the electrode terminals along the flow direction of the cooling medium within the first cooling medium flow path; and
a second conductive linking member which is provided across extensions of respective linking lines of two adjacent first conductive linking members, and connects a pair of the electrode terminals in the direction intersecting with the flow direction of the cooling medium.

4. The battery container unit according to claim 3, further comprising:
a bent cooling medium separator which divides a first cooling medium sub-passage passing along the first conductive linking member and a second cooling medium sub-passage passing along the second conductive linking member.

5. The battery container unit according to claim 4, wherein the cooling medium separator is formed on a wall within the enclosure facing the first conductive linking member and the second conductive linking member.

6. The battery container unit according to claim 2, wherein two of the first cooling medium flow paths are provided near the first end and the second end respectively in the axial direction of the battery module of the enclosure.

7. The battery container unit according to claim 6, wherein the conductive linking member includes:
a plurality of first conductive linking members each of which links an adjacent pair of the electrode terminals along the flow direction of the cooling medium within the first cooling medium flow path; and
a second conductive linking member which is provided across extensions of respective linking lines of two adjacent first conductive linking members, and connects a pair of the electrode terminals in the direction intersecting with the flow direction of the cooling medium.

8. The battery container unit according to claim 7, further comprising:
a bent cooling medium separator which divides a first cooling medium sub-passage passing along the first conductive linking member and a second cooling medium sub-passage passing along the second conductive linking member.

9. The battery container unit according to claim 8, wherein the cooling medium separator is formed on a wall within the enclosure facing the first conductive linking member and the second conductive linking member.

10. The battery container unit according to claim 1, further comprising a flow accelerator, which locally enhances the flow speed of the cooling medium, provided within the first cooling medium flow path in the enclosure.

11. The battery container unit according to claim 10, wherein the flow accelerator includes a protrusion protruding from the enclosure along the axial direction of the battery module and facing the conductive linking member.
